(19) United States
(12) Patent Application Publication
(10) Pub. No.: US 2011/0258413 A1
(43) Pub. Date: Oct. 20, 2011

(54) APPARATUS AND METHOD FOR EXECUTING MEDIA PROCESSING APPLICATIONS

(75) Inventors: Seung-Mo Cho, Seoul (KR); Hyo-Jung Song, Seoul (KR); Sung-Hak Lee, Yongin-si (KR); Dong-Woo Im, Yongin-si (KR); Oh-Young Jang, Suwon-si (KR); Sung-Jong Seo, Hwaseong-si (KR)

(73) Assignee: Samsung Electronics Co., Ltd., Suwon-si (KR)

(21) Appl. No.: 12/982,098

(22) Filed: Dec. 30, 2010

(30) Foreign Application Priority Data
Apr. 19, 2010 (KR) 10-2010-0036022

(51) Int. Cl. G06F 9/00; G06F 9/02; G06F 15/80

(52) U.S. Cl. 712/16; 713/100; 712/E09.002

(57) ABSTRACT

An apparatus and method for executing media processing applications in a heterogeneous multicore system are provided. The media processing application executing apparatus includes a configuration deciding unit to decide a configuration for a combination of computational kernels and cores in which the computation kernels are to be executed. The computation kernels are media processing components included in a media processing application. The media processing application executing apparatus also includes an execution unit including multiple heterogeneous cores, to execute the media processing application based on the determined configuration.

### CROSS-REFERENCE TO RELATED APPLICATION

This application claims the benefit under 35 U.S.C. §119(a) of Korean Patent Application No. 10-2010-0036022, filed on Apr. 19, 2010, the entire disclosure of which is incorporated herein by reference for all purposes.

### BACKGROUND

1. Field

The following description relates to a multicore system, and more particularly, to an apparatus and method for executing media processing applications in a heterogeneous multicore system.

2. Description of the Related Art

Software modules are components of a media processing application. A media framework is a specification which defines how software modules are connected to each other and how they operate with each other, or in other words, how the framework is configured. The media framework may be, for example, an OpenMax, G streamer, and the like. When a media processing application is configured as a pipe line with media processing components, media framework defines interfaces that the individual media processing components should install. Each media processing component may be executed in a core, for example, in a Central Processing Unit (CPU), a Digital Signal Processor (DSP), a Graphic Processing Unit (GPU), and the like.

However, each media processing component is usually developed to be optimized when processed by a target core and is optimally executed only in that target core. Accordingly, media processing components optimized to predetermined target cores cannot be optimally executed in other cores including cores that are developed in the future.

### SUMMARY

In one general aspect, there is provided a media processing application execution apparatus, comprising a configuration deciding unit to determine a configuration for computational kernels and cores in which the computational kernels are to be executed, wherein the computational kernels are media processing components included in a media processing application, and an execution unit, including multiple heterogeneous cores, to execute the media processing application based on the determined configuration.

The configuration deciding unit may extract feasible combinations from among combinations of configurations of the computation kernels and the cores in which the is computational kernels are to be executed, based on information about at least one executable device defined for each computational kernel, and may select an optimal combination from among the feasible combinations.

The configuration deciding unit may test performances of the feasible combinations using sampling data, starting from a combination of cores matching device information on which each computation kernel has a highest preference, based on preference information about at least one executable device defined for each computational kernel, and the preference information may be set in the media processing application.

The configuration deciding unit may change the configuration of the cores to sequentially change the cores from a core that takes the longest time to execute to another core having a second highest preference, and may measure the performance of the changed configuration.

For each media processing component, a port connecting the media processing component with another media processing component, a computational kernel configured to execute the media processing component, an internal buffer for communications between computational kernels, and a direction of data flow between the port, the computational kernel, and the internal buffer, may be defined.

The media processing application may be written in a language for a heterogeneous multicore processor.

In another general aspect, there is provided a media processing application execution method comprising determining a configuration for computational kernels and cores in which the computational kernels are to be executed, wherein the computational kernels are media processing components included in a media processing application, and executing the media processing application based on the decided configuration.

The determining may comprise extracting feasible combinations of configurations including the computation kernels and the cores in which the computational kernels are to be executed, based on information about at least one executable device defined for each computational kernel, and selecting an optimal combination from among the feasible combinations.

The determining may comprise testing performances of the feasible combinations using sampling data, starting from a combination of cores matching device information on which each computational kernel has a highest preference, based on preference information about at least one executable device defined for each computational kernel, and the preference information may be set in the media processing application.

The determining may comprise changing a configuration of the cores in a manner to sequentially change the cores from a core that takes the longest time to execute to another core having a second highest preference, and measuring the performance of the changed configuration.

In another general aspect, there is provided a media processing application execution apparatus, comprising a configuration deciding unit to determine a processing configuration for optimally processing a media processing application using multiple heterogeneous cores, the media processing application comprising a plurality of computational kernels, and the configuration deciding unit determines which heterogeneous core most preferably processes a respective computational kernel, and an execution unit comprising the multiple heterogeneous cores to execute the media processing application based on the determined optimal processing configuration.

The configuration deciding unit may extract possible combinations of the heterogeneous cores that may process the plurality of computational kernels and may determine an optimal combination from the extracted combinations as the determined optimal processing configuration.

Each computational kernel of the media processing application may include processing core preference information, and the configuration deciding unit may extract possible combinations of the heterogeneous cores that may process the plurality of computational kernels based on the processing core preference information of each respective computational kernel.

The configuration deciding unit may determine the optimal processing configuration based on the type of processing cores included in the multiple heterogeneous cores.

Other features and aspects may be apparent from the following description, the drawings, and the claims.

### BRIEF DESCRIPTION OF THE DRAWINGS

FIG. 1 is a diagram illustrating an example of a media processing application executing apparatus including multiple heterogeneous cores.

FIG. 2 is a diagram illustrating an example of media processing components included in a media processing application that is performed in multiple heterogeneous cores.

FIG. 3 is a diagram illustrating an example of media processing components included in two media processing applications that are performed in multiple heterogeneous cores.

FIG. 4 is a flowchart illustrating an example of a method for executing a media processing application.

Throughout the drawings and the description, unless otherwise described, the same drawing reference numerals should be understood to refer to the same elements, features, and structures. The relative size and depiction of these elements may be exaggerated for clarity, illustration, and convenience.

### DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein may be suggested to those of ordinary skill in the art. Also, descriptions of well-known functions and constructions may be omitted for increased clarity and conciseness.

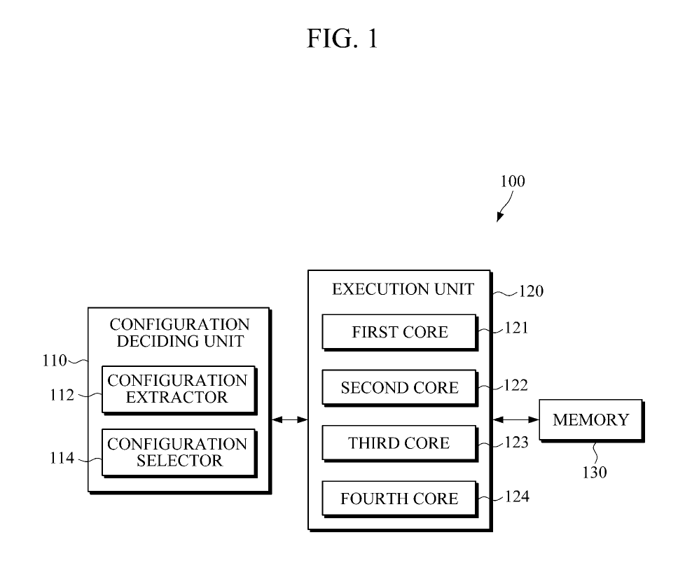

FIG. 1 illustrates an example of a media processing application executing apparatus including multiple heterogeneous cores.

Referring to FIG. 1, media processing application (MPA) executing apparatus 100 includes a configuration deciding unit 110, an execution unit 120, and a memory 130. The MPA executing apparatus 100 may be, for example, a terminal, a PDA, a PMP, a TV, a MP3 player, a mobile phone, and the like.

The MPA executing apparatus 100 executes media processing applications. As an example, a media processing application may be written in a language for a heterogeneous multicore processor, for example, in an Open Computing Language (OpenCL), a Compute Unified Device Architecture (CUDA), and the like. A media processing application may be configured with media processing components. For example, the media processing components may be functional blocks that make up the media processing application. For example, the media processing components may be data processing modules, such as sources, sinks, codecs, filters, splitters, mixers, and the like.

When a media processing application is installed in a system including multiple heterogeneous cores, individual media processing components may be defined. For example, the media processing components may be defined to determine a configuration based on a combination of computational kernels that make up the media processing components and cores is in which the computational kernels will be executed.

For example, each of the media processing components may be defined. As another example, a port connecting one media processing component with another media processing component may be defined. As another example, a computational kernel configured to execute the media processing component may be defined. As another example, an internal buffer for communications between computational kernels may be defined. As another example, the direction of data flow between the port, the computational kernel, and the internal buffer may be defined. The media processing components may be represented by a graph. In the graph, ports, computational kernels, and internal buffers may be expressed as nodes, and the direction of data flows may be expressed as edges between the nodes.

A computational kernel is a code of a specific part (for example, a kernel part) requiring a long execution time from among the software and may be distinguished from a kernel of an operating system (OS). For example, if a media processing component is a video codec, the media processing component may include a motion compensation kernel, a deblock kernel, a Context-adaptative binary arithmetic coding kernel, and the like.

For each computational kernel, information about at least one device that can be executed by the computational kernel may be defined. If the information about at least one executable device defined for each computational kernel includes information on a plurality of devices, information on preferences between the plurality of devices may be further defined. For example, the device information may be information on a device type for a core in which the computational kernel is to be executed. For example, a device having the highest preference may be defined as CPU, a device having the second highest preference may be defined as GPU, a device having the third highest preference may be defined as DSP, and the like.

A port type indicating whether the port is an input type or an output type and a buffer size is may be defined. For the internal buffer, a buffer size corresponds to the size of a buffer used when data is transmitted through the port. Accordingly, for an internal buffer the buffer size may be defined.

In order to execute a media processing application composed of at least one media processing component, the configuration deciding unit 110 may determine a configuration based on a combination of computational kernels that make up the media processing component and cores in which the computational kernels are to be executed. For example, the configuration may be a combination of <computational kernels, core types>. The configuration deciding unit 110 may determine a configuration in which the media processing application can execute an optimal operation with multiple heterogeneous cores.

The execution unit 120 executes the media processing application according to the decided configuration. For example, the execution unit 120 may be a chip-in processor for processing information of the system. The execution unit 120 may be a multicore processor including a plurality of cores, for example, cores 121, 122, 123, and 124 which are mounted onto a single chip.

A core is a processing module which is installed in a processor and executes various functions of the processor. As an example, a core may be classified into a CPU type, a GPU type, a DSP type, and the like, according to its functionality or characteristics. For example, the core may be an INTEL® x86, ARM Cortex-A8, TI DSP C64x, Imagination Technology (IT) SGX530, and the like. The example of FIG. 1 shows four cores, but the number of cores is not limited thereto. For example, the execution unit may include more than four cores or less than four cores.

As another example, the execution unit 120 may be a Heterogeneous multicore processor in which cores having two or more different characteristics are integrated onto one chip. Accordingly, the multicores included in the execution unit 120 may have different magnitudes of vectors with maximum processing capabilities, different power consumptions, and different context switching times. For example, a processor TI OMAP3 includes an ARM Cortex-A8, TI DSP C64x, and IT SGX530.

As illustrated in FIG. 1, the configuration deciding unit 110 may include a configuration extractor 112 and a configuration selector 114.

The configuration extractor 112 extracts possible combinations of devices in which the computational kernels included in the media processing components may be executed, based on the computational kernels and information about at least one executable device defined for each computational kernel.

For example, the configuration extractor 112 may check which cores are present in the execution unit 120 of the application executing apparatus 100 in which the media processing application will be installed and executed. For example, the configuration extractor 112 may acquire device information about the execution unit 120 using an application programming interface (API). Accordingly, the configuration extractor may determine the different cores that are included in the execution unit 120. For example, when OpenCL is used, the configuration extractor 112 may acquire device information about the execution unit 120 using API such as clGetPlatformInfo( ) or clGetDeviceInfo( ). For example, the configuration extractor 112 may use the API to identify that the execution unit 120 is composed of various processors, for example, two CPUs, a GPU, and a DSP.

The configuration selector 114 may select an optimal combination from among the combinations extracted by the configuration extractor 112. For example, the configuration selector 114 may select an optimal combination by testing the performances of the possible combinations. As an example, the configuration selector 114 may begin with a combination of is cores based on device information on which individual computation kernels have the highest preference, wherein the highest preference is determined from the information on preferences.

A process for determining an optimal configuration may be performed during tuning when a media processing application is installed in a terminal.

The configuration selector 114 may compile the computation kernels of the media processing application based on the cores in which the individual computational kernels are executable. For example, the configuration selector 114 may decide an optimal configuration by measuring the performances of the compiled computational kernels. The configuration selector 114 may extract all executable configurations and determine priorities of the extracted configurations for performance measurement based on a predetermined rule. For example, the configuration selector 114 may measure the performances of the configurations using sampling data beginning with a configuration determined to have the highest priority.

As described above, the configuration selector 114 may determine the priorities based on a predetermined rule. For example, the configuration selector 114 may preferentially assign computational kernels to cores designated by a media processing component developer, and measure the execution times of the computational kernels. The configuration selector 114 may perform performance measurement on all of the possible configurations or only on several of the configurations using sampling data, for example, those configurations having relatively higher priorities.

When a computational kernel can be executed in a plurality of cores, the configuration selector 114 may assign the highest priority to a configuration of cores in which the computational kernel has the highest preference and then measure performance of the configuration. For example, the configuration selector 114 may adjust the configuration of cores in a manner to sequentially change cores from a core taking a longest execution time to is another core having the second preference, and measure performance of the changed configuration. For example, the configuration selector 114 may adjust a core that is taking the longest amount of time to execute a computation and replace the core with a core that is determined to have the next highest preference for processing the computation. As another example, the configuration selector 114 may allow as many as possible adjacent computational kernels on a graph of media processing components to be executed on the same core.

The configuration selector 114 may decide priorities for configurations with respect to the numbers of possible combination options based on two or more combined rules. For example, the configuration selector 114 may measure performance while changing target cores for a computational kernel.

For example, the configuration selector 114 may arrange computational kernels in the order of their execution times, and measure performance for each configuration, while changing a core having the highest preference to a core having the second highest preference for each computational kernel, from a computational kernel having the longest execution time to a computational kernel having the shortest execution time. The configuration selector 114 may measure performance for each configuration, while changing the core having the second highest preference to a core having the third highest preference for each computational kernel, and may grade the configurations from the computational kernel having the longest execution time to the computational kernel having the shortest execution time.

As another example, the configuration selector 114 may change cores for two computational kernels to measure performance, as follows. The configuration selector 114 may create a combination of computation kernel pairs, each pair consisting of two computation kernels (for example, <computational kernel 1, computational kernel 2>), calculate a sum of execution times of each computational kernel pair, and arrange the computational kernel pairs in is descending order of the sums of their execution times. In this example, the configuration selector 114 may measure performance for each configuration, while changing a core having the highest preference to a core having the second highest preference for each computational kernel pair, from a computational kernel pair having the greatest sum of execution times to a computational kernel pair having the smallest sum of execution times. Next, the configuration selector 114 may measure performance for each configuration, while changing the core having the second highest preference to a core having the third highest preference for each computational kernel pair, from the computational kernel having the greatest sum of execution times to the computational kernel having the smallest sum of execution times.

As described above, the smaller the sum of execution time the higher the preference the configuration is given. Accordingly, the configuration with the shortest execution time is given the highest preference.

The configuration selector 114 may determine that the configuration having the shorter time for execution of the sample data is the configuration that has the higher performance. For example, when a media processing component is an encoder for processing image frames, its performance may be estimated by measuring a frame transfer speed.

After the configuration selector 114 determines a configuration that has an optimal performance, the execution unit 120 may execute the corresponding media processing application based on the determined configuration. At this time, the execution unit 120 may decide upon a dependency between computational kernels using edges on a diagram of media processing components. Accordingly, the execution unit 120 may determine a topology order for computational kernels to be executed, using data flow information among definition content for media processing components created by the configuration selector 114. For example, the is topology order may be determined as an execution order of computational kernel 1→computational kernel 2→computational kernel 3→computational kernel 4.

The execution unit 120 may assign memory objects to the memory 130. For example, the execution unit 120 may assign memory objects for the functions of internal buffers and buffers for data that are received and transmitted through input and output ports for media processing components. The execution unit 120 may compile the computational kernels to the corresponding cores based on the configuration and then execute the computational kernels.

If the media processing application is an OpenMax-based application, an API, such as EmptyThisBuffer( ) or FillThisBuffer( ), may be used to start execution of the media processing component. The EmptyThisBuffer( ) may be used to transfer a buffer containing data to be executed to an input port of a media processing component and to execute the data. The FullThisBuffer( ) may be used to transfer a buffer to store results to an output port of a media processing component and to store the results.

Through the use of a media processing application composed of media processing components defined to be efficiently executed in various types of heterogeneous multicore systems, the execution performance and portability of the media processing application may be improved.

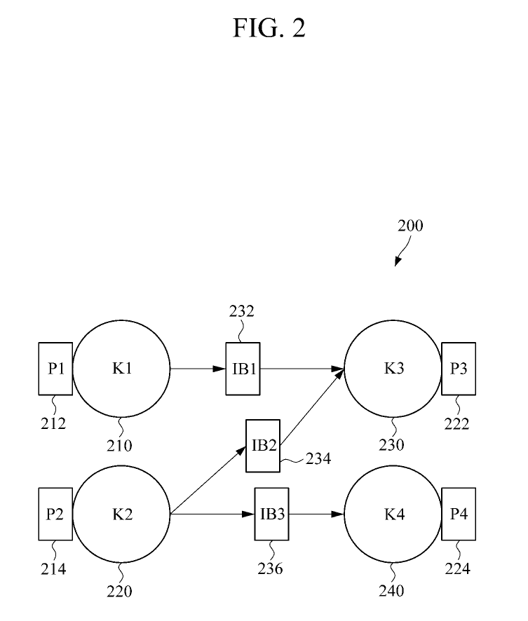

FIG. 2 illustrates an example of media processing components included in a media processing application that is performed in multiple heterogeneous cores.

In the diagram illustrated in FIG. 2, K1 210 represents a computational kernel 1, K2 220 represents a computational kernel 2, K3 230 represents a computational kernel 3, and K4 240 represents a computational kernel 4. For purposes of example only, executable device information for K1 210 may be defined as a CPU and a GPU, and the processing core having the highest preference for K1 210 may be defined as the CPU. That is, K1 may be executed by is either a CPU or a GPU with the CPU being the processing core having the higher preference for executing K1.

P1 212 represents an input port of K1 210 and P2 214 represents an input port of K2 220. For example, if a buffer type for P1 212 is an input type and the buffer size is 10 kB, this represents that data corresponding to 10 kB has to be input through P1 212 in order to execute the K1 210. P3 222 represents an output port of K3 230 and P4 represents an output port of K4 240.

IB1 232 represents an internal buffer between K1 210 and K3 230, IB2 234 represents an internal buffer between K2 214 and K3 230, and IB3 236 represents an internal buffer between K2 214 and K4 224.

For example, in the execution unit 120 of FIG. 1, the computational kernels K1 210, K2 220, K3 230 and K4 240 are enqueued to the corresponding cores in the topological order on the diagram illustrated in FIG. 2, in the order of K1→K2→K3→K4 to execute the computational kernels.

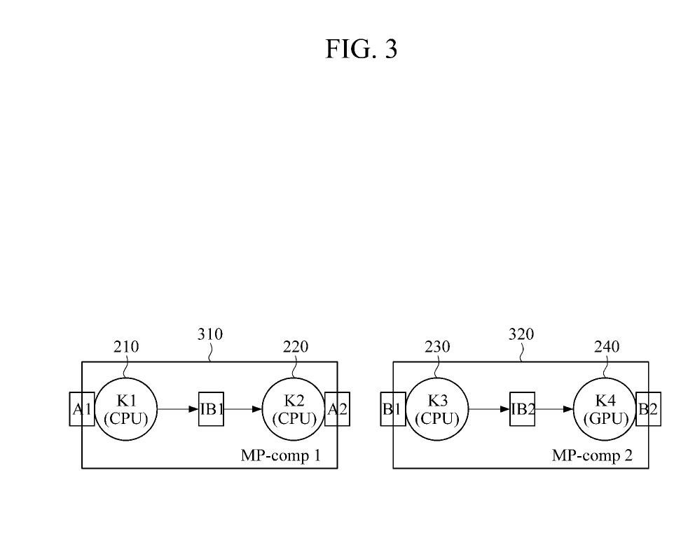

FIG. 3 illustrates an example of media processing components included in two media processing applications that are performed in multiple heterogeneous cores.

In this example, a media processing application is composed of a first media processing component (MP-comp 1) 310 and a second media processing component (MP-comp2) 320, as illustrated in FIG. 3.

For example, the MP-comp 1 310 and MP-comp 2 320 may be defined as shown below.

MP-comp 1 (310):
Port A1 (in)→Computational Kernel 1 (CPU, GPU)→Internal Buffer (10 KB)→Computational Kernel 2 (CPU)→Port A2 (out)

MP-comp 2 (320):
Port B1 (in)→Computational Kernel 3 (CPU, GPU)→Internal Buffer (20 KB)→Computational Kernel 4 (GPU, CPU)→Port B2 (out)

In this example, the content in ( ) represents the attribute of the corresponding node and → represents a data flow direction.

The configuration for executing the media processing application may have a number of various configurations. The configuration deciding unit 110 illustrated in FIG. 1 may determine an optimal configuration from among a plurality of configurations.

In the example of FIG. 3, it is assumed that a configuration {<computational kernel 1, CPU>, <computational kernel 2, CPU>, <computational kernel 3, CPU>, <computational kernel 4, GPU>} has been set to have the highest preference by a media processing component developer. For example, the configuration deciding unit 110 may use sampling data to preferentially measure performance of a core on which each computation kernel has the highest preference. In this example, the execution times of the computational kernel 1 210, computational kernel 2 220, computational kernel 3 230, and computational kernel 4 240 are measured as 40, 30, 20 and 10, respectively.

The configuration selector 114 of the configuration deciding unit 110 may arrange computational kernels in the order of their execution times, and measure performance for each configuration, while changing a core having the highest preference to a core having the second highest preference for each computational kernel, from a computational kernel having the longest execution time to a computational kernel having the shortest execution time. Accordingly, the configuration deciding unit 110 may measure performance for each configuration, while changing a core having the highest preference to a core having the second highest preference for each computational kernel, from the computational kernel 1 210 having the longest execution time to the computational kernel 4 240 having the shortest execution time. The operation may be repeated until performance measurement on all cores contained in preference information is complete.

For example, the configuration deciding unit 110 may measure performance of each configuration in the order of 1, 2, and 3 as shown below.

1. Configuration having the Highest Preference
{<Computational Kernel 1, CPU>, <Computational Kernel 2, CPU>, <Computational Kernel 3, CPU>, and <Computational Kernel 4, GPU>}

2. In the Example of Changing One Computational Kernel
{<Computational Kernel 1, GPU>, <Computational Kernel 2, CPU>, <Computational Kernel 3, CPU>, and <Computational Kernel 4, GPU>}→
{<Computational Kernel 1, CPU>, <Computational Kernel 2, CPU>, <Computational Kernel 3, DSP>, and <Computational Kernel 4, GPU>}→
{<Computational Kernel 1, CPU>, <Computational Kernel 2, CPU>, <Computational Kernel 3, CPU>, and <Computational Kernel 4, CPU>}

The configuration selector 114 may measure performance for each configuration, while changing a core having the highest preference to a core having the second highest preference for each computational kernel pair, from a computational kernel pair having the greatest sum of execution times to a computational kernel pair having the smallest sum of execution times. For example, when performance is measured for a pair of computational kernels while changing cores, the performance measurement may be performed in the following order.

2. In the Example of Changing Two Computational Kernels
{<Computational Kernel 1, GPU>, <Computational Kernel 2, CPU>, <Computational Kernel 3, DSP>, and <Computational Kernel 4, GPU>}→
{<Computational Kernel 1, GPU>, <Computational Kernel 2, CPU>, <Computational is Kernel 3, CPU>, and <Computational Kernel 4, CPU>}→
{<Computational Kernel 1, CPU>, <Computational Kernel 2, CPU>, <Computational Kernel 3, DSP>, and <Computational Kernel 4, CPU>}

When the performance measurement is performed in this way, the maximum number of configurations may be represented as N_{d}^{̂}Nₖ configurations, wherein N_{d} is the number of cores included in the application executing apparatus 100 and Nₖ is the number of computational kernels in one media processing application.

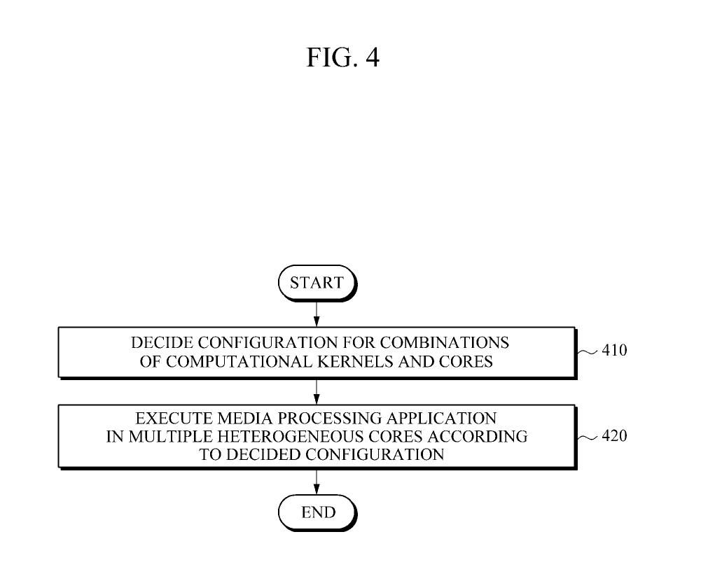

FIG. 4 illustrates an example of a method for executing a media processing application.

Referring to FIG. 4, in 410 an application executing apparatus determines configurations corresponding to combinations of computational kernels included in media processing components and cores in which the computational kernels are to be executed. The application executing apparatus may determine an optimal configuration by which a media processing application composed of at least one media processing component can execute an optimal operation for multiple heterogeneous cores.

For example, the application executing apparatus may extract feasible combinations from among combinations of devices in which computational kernels belonging to each media processing component can be executed, using information about at least one executable device defined for each computational kernel. The application executing apparatus may select an optimal combination from among the feasible combinations. At this time, a configuration deciding unit of the application executing apparatus may test the performances of the feasible combinations, starting from a combination of cores matching device information on which each computation kernel has the highest preference, based on information on preferences.

In 420, the application executing apparatus executes the media processing application in the multiple heterogeneous cores according to the decided configuration.

As described herein, the application execution apparatus includes a configuration deciding unit and an execution unit. The configuration deciding unit determines which processing cores should process which kernel computations. The execution unit then executes that kernel computations based on the determined configuration of processing cores. The configuration deciding unit may further sample the execution results and adjust which processing cores process which kernel computations, and therefore establish preferences. For example, each computational kernel may be assigned a specific core having a higher preference from among a plurality of processing cores. By determining the most preferable processing core for each kernel computation, the processing speed of the apparatus may be improved, and the overall processing speed of the apparatus may be more efficient.

As a non-exhaustive illustration only, the terminal device described herein may refer to mobile devices such as a cellular phone, a personal digital assistant (PDA), a digital camera, a portable game console, an MP3 player, a portable/personal multimedia player (PMP), a handheld e-book, a portable lab-top personal computer (PC), a global positioning system (GPS) navigation, and devices such as a desktop PC, a high definition television (HDTV), an optical disc player, a setup box, and the like, capable of wireless communication or network communication consistent with that disclosed herein.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer.

It should be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

The processes, functions, methods and/or software described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a is described system, architecture, device, or circuit are combined in a different manner and/or replaced or supplemented by other components or their equivalents. Accordingly, other implementations are within the scope of the following claims.

What is claimed is:

1. A media processing application execution apparatus, comprising:
a configuration deciding unit to determine a configuration for computational kernels and cores in which the computational kernels are to be executed, wherein the computational kernels are media processing components included in a media processing application; and
an execution unit, including multiple heterogeneous cores, to execute the media processing application based on the determined configuration.

2. The media processing application execution apparatus of claim 1, wherein the configuration deciding unit extracts feasible combinations from among combinations of configurations of the computation kernels and the cores in which the computational kernels are to be executed, based on information about at least one executable device defined for each computational kernel, and selects an optimal combination from among the feasible combinations.

3. The media processing application execution apparatus of claim 1, wherein the configuration deciding unit tests performances of the feasible combinations using sampling data, starting from a combination of cores matching device information on which each computation kernel has a highest preference, based on preference information about at least one executable device defined for each computational kernel, and the preference information is set in the media processing application.

4. The media processing application execution apparatus of claim 3, wherein the configuration deciding unit changes the configuration of the cores to sequentially change the cores from a core that takes the longest time to execute to another core having a second highest preference, and measure the performance of the changed configuration.

5. The media processing application execution apparatus of claim 1, wherein for each media processing component, a port connecting the media processing component with another media processing component, a computational kernel configured to execute the media processing component, an internal buffer for communications between computational kernels, and a direction of data flow between the port, the computational kernel, and the internal buffer, are defined.

6. The media processing application execution apparatus of claim 1, wherein the media processing application is written in a language for a heterogeneous multicore processor.

7. A media processing application execution method comprising:
is determining a configuration for computational kernels and cores in which the computational kernels are to be executed, wherein the computational kernels are media processing components included in a media processing application; and
executing the media processing application based on the decided configuration.

8. The media processing application execution method of claim 7, wherein the determining comprises:
extracting feasible combinations of configurations including the computation kernels and the cores in which the computational kernels are to be executed, based on information about at least one executable device defined for each computational kernel; and
selecting an optimal combination from among the feasible combinations.

9. The media processing application execution method of claim 7, wherein the determining comprises testing performances of the feasible combinations using sampling data, starting from a combination of cores matching device information on which each computational kernel has a highest preference, based on preference information about at least one executable device defined for each computational kernel, and the preference information is set in the media processing application.

10. The media processing application execution method of claim 9, wherein the determining comprises changing a configuration of the cores in a manner to sequentially change the cores from a core that takes the longest time to execute to another core having a second highest preference, and measuring the performance of the changed configuration.

11. A media processing application execution apparatus, comprising:
a configuration deciding unit to determine a processing configuration for optimally processing a media processing application using multiple heterogeneous cores, the media processing application comprising a plurality of computational kernels, and the configuration deciding unit determines which heterogeneous core most preferably processes a respective computational kernel; and
an execution unit comprising the multiple heterogeneous cores to execute the media processing application based on the determined optimal processing configuration.

12. The media processing application execution apparatus of claim 11, wherein the configuration deciding unit extracts possible combinations of the heterogeneous cores that may process the plurality of computational kernels and determines an optimal combination from the extracted combinations as the determined optimal processing configuration.

13. The media processing application execution apparatus of claim 11, wherein each computational kernel of the media processing application includes processing core preference information, and the configuration deciding unit extracts possible combinations of the heterogeneous cores that may process the plurality of computational kernels based on the processing core preference information of each respective computational kernel.

14. The media processing application execution apparatus of claim 11, wherein the configuration deciding unit determines the optimal processing configuration based on the type of processing cores included in the multiple heterogeneous cores.
